(19) United States
(12) Patent Application Publication
(10) Pub. No.: US 2002/0130833 A1
(43) Pub. Date: Sep. 19, 2002

(54) Adjustable parallax plate assembly for viewing three-dimensional images on a display unit

(76) Inventor: Chung-Liang Chiao, Taichung City (TW)

Correspondence Address: HARNESS, DICKEY & PIERCE, P.L.C., P.O. BOX 828, BLOOMFIELD HILLS, MI, 48303, US

(21) Appl. No.: 09/809,368

(22) Filed: Mar. 15, 2001

(51) Int. Cl. G09G 5/00

(52) U.S. Cl. 345/156; 348/42

(57) ABSTRACT

An adjustable parallax plate assembly is used when viewing three-dimensional images on a display unit, and includes an elongate mounting rail that extends horizontally and that is mounted on an upper part of the display unit, adjustable left and right mounting frames mounted on and horizontally spaced apart from each other along the mounting rail, and movable horizontally and vertically relative to the mounting rail, and a parallax plate disposed in front of a display panel of the display unit, and having an upper frame portion coupled to the mounting frames.

### BACKGROUND OF THE INVENTION

1. Field of the Invention

The invention relates to the viewing of three-dimensional images on a display unit, more particularly to an adjustable parallax plate assembly for viewing three-dimensional images on a display unit.

2. Description of the Related Art

It is known in the art that the left and right eyes of humans can be used to form a vision of an object independently. In other words, the left eye can perceive a left image, whereas the right eye can perceive a right image. The left and right images are then fused in the human brain to generate a stereoscopic image. In order to view a three-dimensional image on a display unit, it is necessary to enable the left and right eyes to view independent images. To achieve this end, a parallax plate, such as a light grating plate or a lenticule array plate, is disposed in front of a display panel of the display unit such that the left eye is able to view only a left image on the display panel, and such that the right eye is able to view only a right image on the display panel. By interleaving the display of the left and right images on the display panel at a relatively fast rate, the human brain is thus able to perceive the three-dimensional image on the display unit. Such a technique has been utilized in the autostereoscopic display apparatus proposed in U.S. Pat. No. 6,064,424. However, a main drawback of the apparatus taught in the aforesaid patent resides in that the lenticular sheet employed therein is not adjustable relative to the display panel for varying the parallax effect attributed thereto according to the individual user's viewing requirement.

### SUMMARY OF THE INVENTION

Therefore, the main object of the present invention is to provide a simple yet easy to adjust parallax plate assembly for viewing three-dimensional images on a display unit.

According to the present invention, an adjustable parallax plate assembly for a display unit comprises:

an elongate mounting rail that extends horizontally and that is adapted to be mounted on an upper part of the display unit;

adjustable left and right mounting frames mounted movably on the mounting rail and horizontally spaced apart from each other along the mounting rail, each of the left and right mounting frames being movable horizontally and vertically relative to the mounting rail; and

a parallax plate adapted to be disposed in front of a display panel of the display unit, and having an upper frame portion coupled to the left and right mounting frames.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of the preferred embodiment of an adjustable parallax plate assembly according to the present invention;

FIG. 2 is an assembled perspective view showing the preferred embodiment when mounted on a display unit;

FIG. 3 is a schematic horizontal sectional view illustrating how horizontal adjustment of the preferred embodiment is conducted with respect to the display unit;

FIG. 4 is a schematic horizontal sectional view illustrating how vertical adjustment of the preferred embodiment is conducted with respect to the display unit;

FIG. 5 is a schematic vertical sectional view showing the preferred embodiment when mounted on the display unit; and

FIGS. 6 and 7 are schematic top views to illustrate how forward and rearward adjustment of the preferred embodiment is conducted with respect to the display unit.

### DETAILED DESCRIPTION OF THE PREFERRED EMBODIMENT

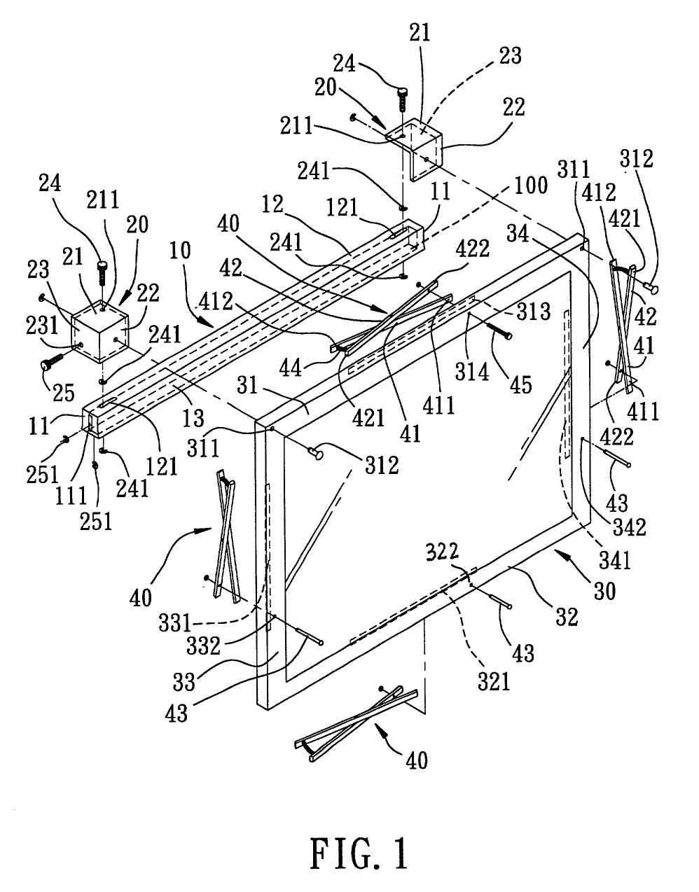

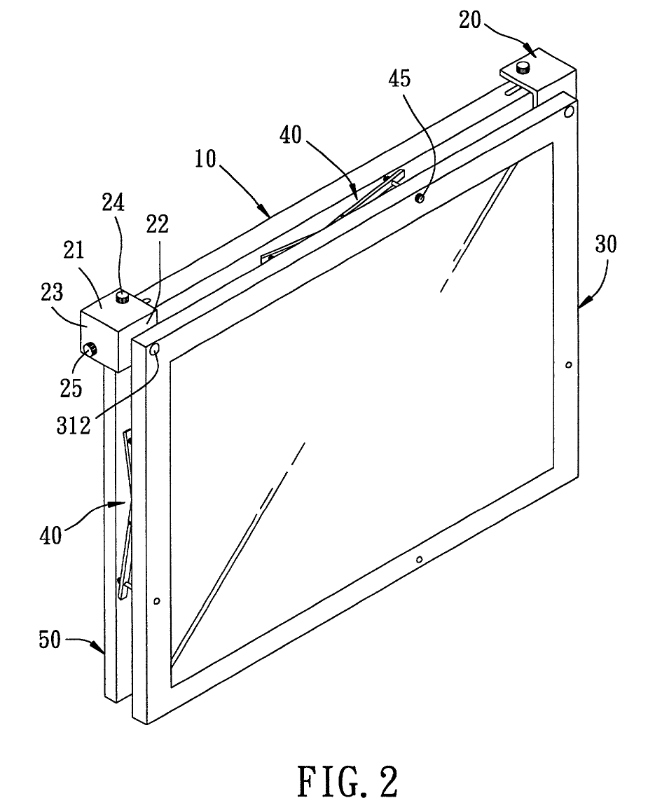

Referring to FIGS. 1, 2 and 3, the preferred embodiment of an adjustable parallax plate assembly according to the present invention is shown to comprise an elongate mounting rail 10, adjustable left and right mounting frames 20, a parallax plate 30, and four support units 40.

The mounting rail 10 extends horizontally and includes a rectangular top wall 12, left and right side walls 11 that extend downwardly and respectively from left and right edges of the top wall 12, and front and rear side walls 13 that extend downwardly and respectively from front and rear edges of the top wall 12. The mounting rail 10 is thus configured with a downwardly opening cavity 100 that is adapted to receive an upper part of a liquid crystal display unit 50 such that the top wall 12 is disposed on a top wall portion 51 of the display unit 50, the left and right side walls 11 are disposed adjacent to left and right wall portions 53, 54 of the display unit 50, and the front and rear side walls 13 are disposed adjacent to front and rear wall portions of the display unit 50. In this embodiment, the left side wall 11 is formed with a vertical slot 111 therethrough. In addition, the top wall 12 has left and right end portions formed with a respective horizontal slot 121 therethrough.

Each of the mounting frames 20 includes a rectangular top wall part 21 that is to be disposed on top of a respective one of the left and right end portions of the top wall 12 of the mounting rail 10, a front wall part 22 that extends downwardly from a front edge of the top wall part 21 and that is to be disposed adjacent to the front side wall 13 of the mounting rail 10, and a side wall part 23 that extends downwardly from a side edge of the top wall part 21 and that is to be disposed adjacent to a respective one of the left and right side walls 11 of the mounting rail 10. The top wall part 21 is formed with a screw hole 211 that is registered with a respective one of the horizontal slots 121 in the top wall 12 of the mounting rail 10. The side wall part 23 of the left mounting frame 20 is formed with a screw hole 231 that is adjacent to and that is registered with the vertical slot 111 in the left side wall 11 of the mounting rail 10. Each of a pair of screw fasteners 24 extends threadedly through the screw hole 211 in a respective one of the mounting frames 20, and further extends through a respective one of the horizontal slots 121 in the mounting rail 10. Each screw fastener 24 engages a respective pair of C-rings 241 that are disposed on upper and lower surfaces of the top wall 12 for positioning the screw fastener 24 such that the screw fasteners 24 are slidable and rotatable in the respective horizontal slot 121. A screw fastener 25 extends threadedly through the screw hole 231 in the left mounting frame 20, and further extends through the vertical slot 111 in the mounting rail 10. The screw fastener 25 engages a pair of C-rings 251 that are disposed on inner and outer surfaces of the left side wall 11 for positioning the screw fastener 25 such that the screw fastener 24 is slidable and rotatable in the vertical slot 111.

The parallax plate 30, such as a light grating plate or a lenticule array plate, is to be disposed in front of a display panel of the display unit 50, and has an upper frame portion 31 with left and right top corner portions, each of which is formed with a fastener hole 311. Each of a pair of pins 312 extends through a respective one of the fastener holes 311 and is connected to the front wall part 22 of a respective one of the mounting frames 20, thereby enabling the parallax plate 30 to move forwardly or away from the display unit 50, and rearwardly or toward the display unit 50. Each of the upper, lower, left and right frame portions 31, 32, 33, 34 of the parallax plate 30 has a rear side formed with an elongate receiving groove 313, 321, 331, 341. Each of the frame portions 31, 32, 33, 34 is further formed with a mounting hole 314, 322, 332, 342 that is registered with an end portion of the corresponding receiving groove 313, 321, 331, 341. The mounting hole 314 in the upper frame portion 31 is internally threaded.

Each of the support units 40 is disposed in a respective one of the receiving grooves 313, 321, 331, 341, such that the support unit 40 in the receiving groove 313 is disposed between the upper frame portion 31 of the parallax plate 30 and the front side wall 13 of the mounting rail 10, such that the support unit 40 in the receiving groove 321 is disposed between the lower frame portion 32 of the parallax plate 30 and the lower part of the display unit 50, such that the support unit 40 in the receiving groove 331 is disposed between the left frame portion 33 of the parallax plate 30 and the left part of the display unit 50, and such that the support unit 40 in the receiving groove 341 is disposed between the right frame portion 34 of the parallax plate 30 and the right part of the display unit 50. Each support unit 40 includes first and second support rods 41, 42 having intermediate portions that are pivoted together to form the support unit 40 with a cross-shaped structure. Each of the first and second support rods 41, 42 further has a first end portion 411, 421 abutting against the parallax plate 30, and an opposite second end portion 412, 422 that extends toward the display unit 50 so as to abut against one of the mounting rai11 0 and the display unit 50. Each of the support units 40 further includes a spring 44 disposed between the first end portion 421 of the second support rod 42 and the second end portion 412 of the first support rod 41. Each of three pins 43 extends through a respective one of the mounting holes 322, 332, 342 in the parallax plate 30 and is connected to the second end portion 422 of the second support rod 42 of the respective support unit 40. An adjustment screw 45 extends threadedly through the mounting hole 314 in the parallax plate 30 and is connected to the second end portion 422 of the second support rod 42 of the corresponding support unit 40.

In use, the mounting rail 10 is mounted on the upper part of the display unit 50, and the mounting frames 20 are mounted movably on the left and right end portions of the mounting rail 10 in the aforesaid manner such that the latter are horizontally spaced apart from each other along the mounting rail 10. The parallax plate 30 is then disposed in front of the display panel of the display unit 50 and is coupled to the mounting frames 20 such that the support units 40 are disposed between the parallax plate 30 and one of the mounting rail 10 and the display unit 50. The springs 44 provide stability in the position of the parallax plate 30 relative to the display unit 50. Three-dimensional images can be viewed on the display unit 50 by virtue of the shielding effect of the parallax plate 30. Accordingly, when viewing two-dimensional images on the display unit 50, the mounting rail 10 can be easily removed from the display unit 50.

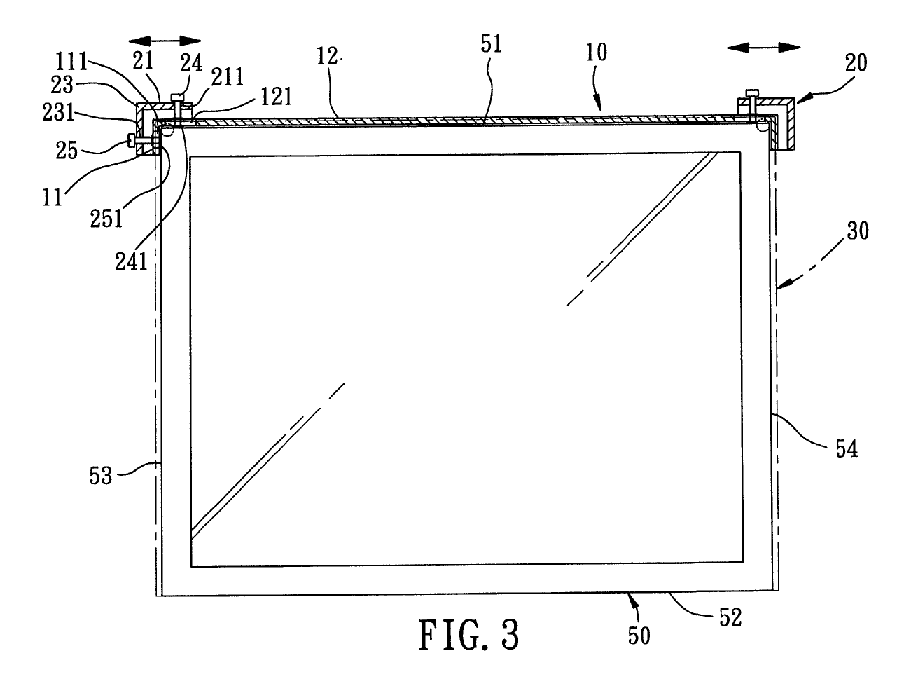

In the aforesaid U.S. Pat. No. 6,064,424, the lenticular elements in the lenticular sheet are slanted with respect to display pixel columns for optimum viewing of motion three-dimensional color images. Likewise, in the assembly of the present invention, light grating units or lenticule array units on the parallax plate 30 are also slanted with respect to the pixel columns on the display panel of the display unit 50. With reference to FIG. 3, by virtue of the threaded engagement between the screw fastener 25 and the screw hole 231 in the left mounting frame 20, the sliding and rotatable engagement between the screw fastener 25 and the vertical slot 111 in the mounting rail 10, and the sliding and rotatable engagement between the screw fasteners 24 and the horizontal slots 121 in the mounting rail 10, and because the parallax plate 30 is mounted on the front wall parts 22 of the mounting frames 20, rotation of the screw fastener 25 will result in horizontal adjustment of the parallax plate 30 relative to the display unit 50.

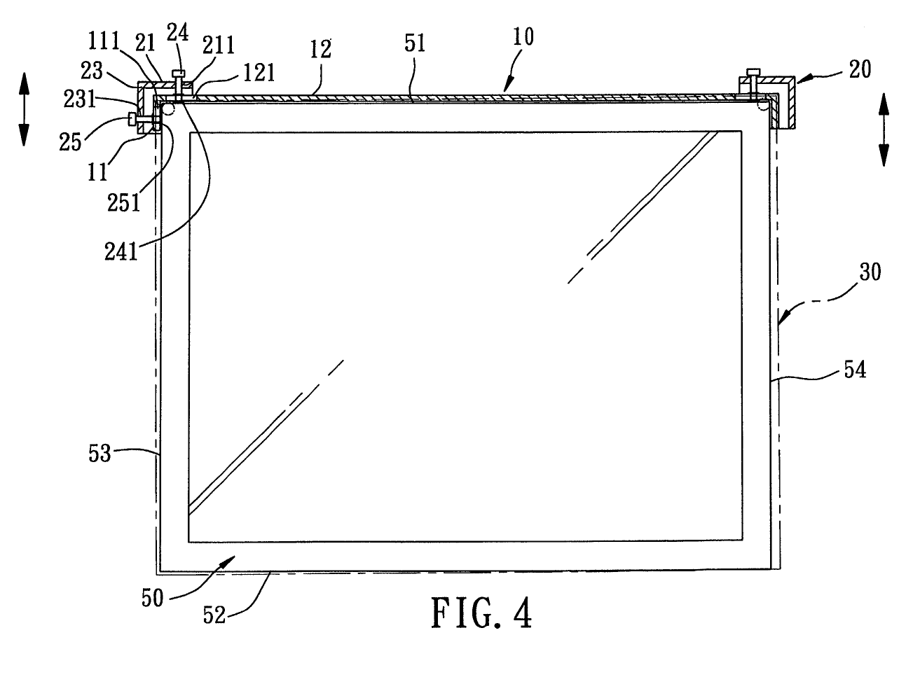

With reference to FIG. 4, by virtue of the threaded engagement between the screw fasteners 24 and the screw holes 211 in the mounting frames 20, the sliding and rotatable engagement between the screw fasteners 24 and the horizontal slots 121 in the mounting rail 10, and the sliding and rotatable engagement between the screw fastener 25 and the vertical slot 111 in the mounting rail 10, and because the parallax plate 30 is mounted on the front wall parts 22 of the mounting frames 20, rotation of the screw fasteners 24 will result in vertical adjustment of the parallax plate 30 relative to the display unit 50.

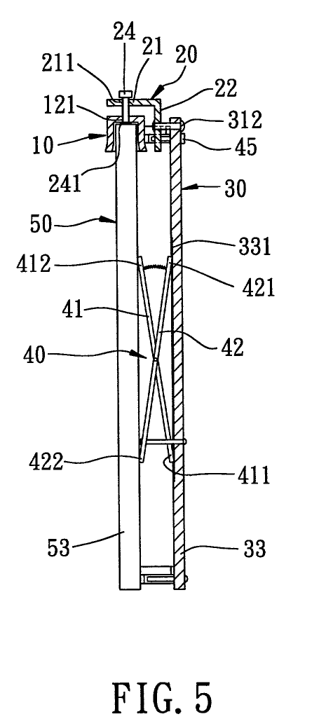

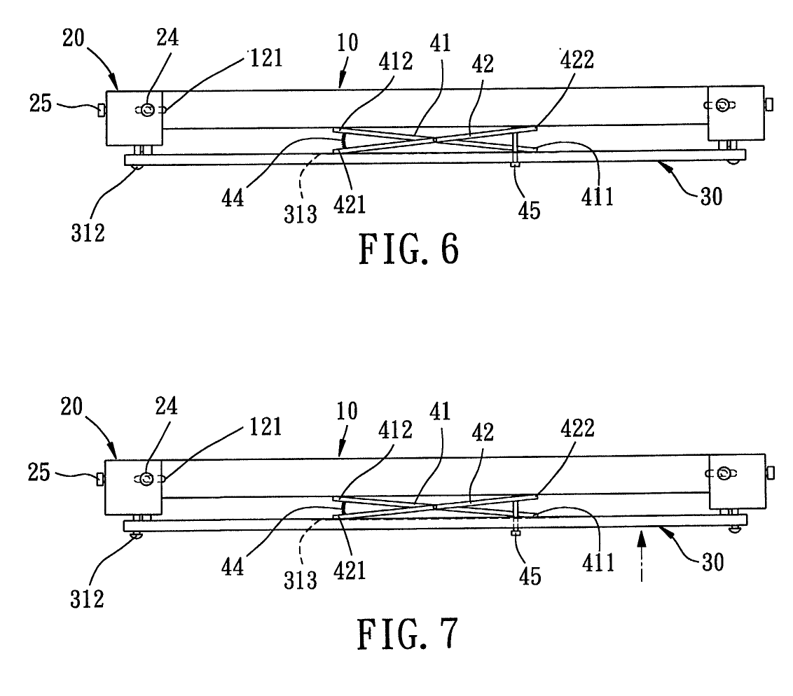

Referring to FIGS. 5, 6 and 7, by operating the adjustment screw 45, the parallax plate 30 can be moved toward the display unit 50 to thereby compress the springs 44, or away from the display unit 50 to release the springs 44 from compression.

It has thus been shown that the parallax plate assembly of this invention can be easily installed on a display unit when it is desired to view three-dimensional images on the latter. In addition, the parallax plate can be adjusted horizontally, vertically and forwardly or rearwardly relative to the display panel of the display unit so as to result in a parallax effect that suits the individual user's viewing requirement.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. An adjustable parallax plate assembly adapted for use with a display unit for viewing three-dimensional images, the display unit having a display panel, said adjustable parallax plate assembly comprising:
an elongate mounting rail that extends horizontally and that is adapted to be mounted on an upper part of the display unit;
adjustable left and right mounting frames mounted movably on said mounting rail and horizontally spaced apart from each other along said mounting rail, each of said left and right mounting frames being movable horizontally and vertically relative to said mounting rail; and
a parallax plate adapted to be disposed in front of the display panel, and having an upper frame portion coupled to said left and right mounting frames.

2. The adjustable parallax plate assembly as claimed in claim 1, the upper part of the display unit having a top wall portion, left and right wall portions, and front and rear wall portions, wherein said mounting rail includes:
a rectangular top wall with opposite left and right edges, and opposite front and rear edges;
left and right side walls that extend downwardly and respectively from said left and right edges of said top wall; and
front and rear side walls that extend downwardly and respectively from said front and rear edges of said top wall;
said mounting rail being configured with a downwardly opening cavity that is adapted to receive the upper part of the display unit therein such that said top wall of said mounting rail is adapted to be disposed on the top wall portion of the upper part of the display unit, such that said left and right side walls are adapted to be disposed adjacent to the left and right wall portions of the upper part of the display unit, and such that said front and rear side walls are adapted to be disposed adjacent to the front and rear wall portions of the upper part of the display unit.

3. The adjustable parallax plate assembly as claimed in claim 2, wherein each of said left and right mounting frames includes:
a top wall part to be disposed on top of said top wall of said mounting rail, and having front and side edges;
a front wall part that extends downwardly from said front edge of said top wall part and that is to be disposed adjacent to said front side wall of said mounting rail; and
a side wall part that extends downwardly from said side edge of said top wall part and that is to be disposed adjacent to one of said left and right side walls of said mounting rail.

4. The adjustable parallax plate assembly as claimed in claim 3, wherein:
said top wall of said mounting rail is formed with a pair of horizontal slots therethrough;
said top wall part of each of said left and right mounting frames being formed with a screw hole that is registered with a respective one of said horizontal slots;
said adjustable parallax plate assembly further comprising a pair of screw fasteners, each of which extends threadedly through said screw hole in said top wall part of a respective one of said left and right mounting frames, and is coupled to said top wall of said mounting rail so as to be slidable and rotatable in the registered one of said horizontal slots.

5. The adjustable parallax plate assembly as claimed in claim 3, wherein:
one of said left and right side walls of said-mounting rail is formed with a vertical slot therethrough;
said side wall part of one of said left and right mounting frames being formed with a screw hole that is adjacent to and that is registered with said vertical slot;
said adjustable parallax plate assembly further comprising a screw fastener which extends threadedly through said screw hole and which is coupled to said mounting rail so as to be slidable and rotatable in said vertical slot.

6. The adjustable parallax plate assembly as claimed in claim 3, wherein said upper frame portion of said parallax plate is mounted on said front wall parts of said left and right mounting frames such that said parallax plate is further movable toward and away from the display unit.

7. The adjustable parallax plate assembly as claimed in claim 6, wherein said parallax plate further has a lower frame portion opposite to said upper frame portion, and opposite left and right frame portions, said adjustable parallax plate assembly further comprising at least one pair of support units disposed on a rear side of said parallax plate, said support units in said pair being respectively disposed at one pair of said upper and lower frame portions and said left and right frame portions,
each of said support units including first and second support rods having intermediate portions that are pivoted together, each of said first and second support rods further having a first end portion abutting against said rear side of said parallax plate, and an opposite second end portion that extends toward the display unit,
each of said support units further including a spring disposed between said first end portion of said second support rod and said second end portion of said first support rod,
one of said support units further including a pin for connecting said second end portion of said second support rod to said parallax plate,
the other one of said support units further including an adjustment screw that extends threadedly through said parallax plate and that is connected to said second end portion of said second support rod.
